(19) United States
(12) Patent Application Publication
(10) Pub. No.: US 2016/0259783 A1
(43) Pub. Date: Sep. 8, 2016

(54) COMPUTER SYSTEM

(71) Applicant: HITACHI, LTD., Tokyo (JP)

(72) Inventors: Masanori Takata, Tokyo (JP); Masakuni Agetsuma, Tokyo (JP); Hiromu Hota, Tokyo (JP); Masaaki Iwasaki, Tokyo (JP)

(73) Assignee: Hitachi, Ltd., Tokyo (JP)

(21) Appl. No.: 14/424,646

(22) PCT Filed: Mar. 26, 2014
(86) PCT No.: PCT/JP2014/058636

§ 371 Date: Feb. 27, 2015

(51) Int. Cl. G06F 17/30

(52) U.S. Cl. CPC G06F 17/303; G06F 17/30569

(57) ABSTRACT

Provided is a method for retaining metadata inheritance relationship in an object storage and for interpreting the relationship. A file and directory inheriting metadata of an upper-level directory allocates the UUID of an object corresponding to the inheritance source directory to metadata of an object of a CAS device corresponding to the file and directory as inheritance information. The inheritance information stored in the CAS device is interpreted in a metadata conversion apparatus (see FIG. 1).

### TECHNICAL FIELD

The present invention relates to computer systems and a technology for, in a system in which data stored in a network-attached storage (NAS) is transferred to a content-addressed storage (CAS), for example, retaining an inheritance relationship of the metadata of a file retained in the NAS in the CAS.

### BACKGROUND ART

The amount of digital data, particularly file data, is rapidly increasing. A NAS device is a storage device for sharing files among a number of computers via a network. A CAS device is a storage device for long term data archiving.

A system is known in which a CAS device is disposed at a data center and a NAS device is disposed at each site (such as the head office and branch offices of a company), where the devices are connected via a communication network so that data on the distributed NAS devices can be consolidated in the CAS device.

The NAS device manages files in a tree structure using a file system, and includes the function for allowing various metadata of an upper-level directory to be inherited by a lower-level directory/file by utilizing the tree structure. Examples of the metadata having the inheritance function include an access control list (ACL) which is access control information, and custom metadata defined by a user.

On the other hand, the CAS device is an object storage that manages data using mutually independent objects. Because the address space is flat, the inheritance mechanism of the NAS device based on the tree structure cannot be migrated to the CAS device.

In order to address such situation, Patent Literature 1, e.g., discloses a method whereby, with regard to data migration, when a migration target directory is inheriting the access control information of a parent directory, the access control information is uniquely set. More specifically, in the system, when a lower-level file inherits the metadata of an upper-level directory, the access control information of the inheritance source directory is copied with regard to that file and stored in the CAS. Namely, the system eliminates the inheritance information itself.

### CITATION LIST

### Patent Literature

Patent Literature 1: US2012/0102069A1

### SUMMARY OF THE INVENTION

### Technical Problem

However, according to the technology of Patent Literature 1, when the inheritance source metadata is modified in a NAS device, the metadata of all of directories/files that are inheriting the inheritance source directory need to be updated in the CAS device to which the data is migrated. Thus, there is the problem of an increase in I/O and an increase in network traffic.

The present invention was made in view of such circumstance, and provides a technology for realizing an inheritance mechanism in the CAS device that normally does not have an inheritance function.

### Solution to the Problem

In order to solve the problem, according to the present invention, the inheritance information of metadata managed in a NAS device is stored in the metadata of each object in a CAS device, and the inheritance information is used at the time of metadata search and object access. More specifically, when data is transferred from the NAS device to the CAS device, a file inheriting the metadata of an upper-level directory allocates, as inheritance information, the Universally Unique Identifier (UUID) that is the address information of an object of the CAS device corresponding to the inheritance source directory to the metadata of an object of the CAS device corresponding to the file. A metadata conversion apparatus interprets the inheritance information stored in the CAS device. During a metadata search of the objects stored in the CAS device, a list of inheriting objects is acquired if the object of the search result is an inheritance source, and a search result is output to the request source. At the time of accessing the objects stored in the CAS device, if the ACL of an access target object is inheriting the upper-level directory, the ACL is acquired from the inheritance source object, and access permission determination is made.

Additional features related to the present invention will become apparent from the description of the present specification and the attached drawings. Various aspects of the present invention may be achieved or realized by various elements and combinations thereof and by the following detailed description and the scope of the attached claims.

It should be understood that the following description in the present specification merely provides typical examples and is not in any way intended to limit the scope of the claims or the application examples.

### Advantageous Effects of Invention

According to the present invention, I/O by an update of inheritance source metadata can be mitigated, search time can be reduced, and security can be ensured by performing access control on a CAS device.

### BRIEF DESCRIPTION OF THE DRAWINGS

FIG. 1 illustrates a physical configuration of a typical system according to embodiment and an outline of the embodiment.

FIG. 2 illustrates an example of a search process according to the embodiment.

FIG. 3 illustrates a hardware and software configuration example of a NAS device.

FIG. 4 illustrates a hardware and software configuration example of a CAS device.

FIG. 5 illustrates a hardware and software configuration example of a metadata conversion apparatus.

FIG. 6 illustrates a configuration example of metadata of files and directories retained in the NAS device.

FIG. 7 illustrates a configuration example of metadata of objects retained in the CAS device.

FIG. 8 illustrates a configuration example of directory objects retained in the CAS device.

FIG. 9 is a flow chart illustrating an archiving process according to an embodiment.

FIG. 10 is a flow chart illustrating a search process according to an embodiment.

FIG. 11 is a flow chart illustrating an inheriting object acquisition process according to a first embodiment.

FIG. 12 is a flow chart illustrating an access permission determination process according to an embodiment.

FIG. 13 is a flow chart illustrating an access process according to an embodiment.

FIG. 14 is a flow chart illustrating a renaming process according to an embodiment.

FIG. 15 illustrates a configuration example of directory objects retained in the CAS device according to a second embodiment.

FIG. 16 is a flow chart illustrating an inheriting object acquisition process according to the second embodiment.

### DESCRIPTION OF EMBODIMENTS

In the following, embodiments will be described with reference to the attached drawings. In the attached drawings, functionally similar elements may be designated with similar numerals. While the attached drawings illustrate specific embodiments and implementation examples in accordance with the principle of the present invention, these are for facilitating an understanding of the present invention and are not to be taken to interpret the present invention in a limited sense.

While the embodiments will be described in such sufficient detail as to enable one skilled in the art to implement the present invention, it should be understood that other implementations or forms are also possible, and that various modifications of the configurations or structures or substitutions of various elements may be made without departing from the scope and spirit of the technical concept of the present invention. Thus, the following descriptions should not be taken as limiting the present invention.

The embodiments may be implemented by software running on a general-purpose computer, dedicated hardware, or a combination of software and hardware, as will be described later.

While information used in the embodiments will be described with reference to tables and lists illustrated in the drawings attached to the specification, the information are not limited to those provided in table or list structure and may include information that does not depend on data structure.

While in the following description the contents of information may be described using terms such as “identifier”, “designation”, “name”, or “ID”, these may be substituted with one another.

A communication network between NAS and CAS is not limited to the adoption of WAN and may adopt a communication network such as a local area network (LAN). The embodiments in their various aspects are not limited to the adoption of Network File System (NFS) protocol and may adopt other file sharing protocols such as Common Internet File System (CIFS) or Hypertext Transfer Protocol (HTTP).

### (1) First Embodiment

### <Computer System Configuration, and Process Outline>

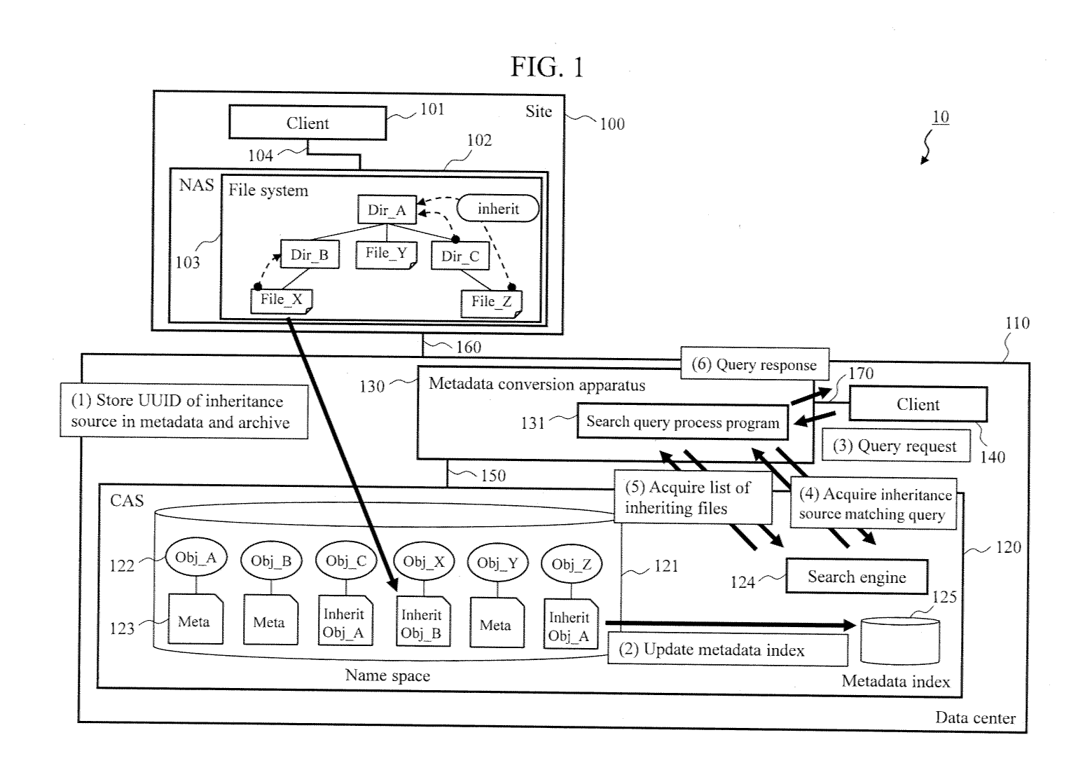

FIG. 1 illustrates a physical configuration example of a computer system according to an embodiment, and the outline of the embodiment.

A computer system 10 includes a site 100 comprising a client 101 and a NAS device 102; and a data center 110 comprising a CAS device 120, a metadata conversion apparatus 130, and a client 140. The site 100 and the data center 110 are connected via a network 160.

The client 101 and the NAS device 102 are connected via a network 104. The client 101 includes one or a plurality computers that utilize a file sharing service provided by the NAS device 102. The client 101 utilizes the file sharing service provided by the NAS device 102 via the network 104 by utilizing a file sharing protocol such as Network File System (NFS) or Common Internet File System (CIFS). While in FIG. 1 the site 100 comprises the client 101 and the NAS device 102, the computers connected to the data center 110 are not limited to these devices. For example, a terminal such as a notebook PC or a smartphone may provide a computer corresponding to the site 100. Thus, the computer corresponding to the NAS device 102 may be defined as a computer that provides data to a user (data providing computer).

The metadata conversion apparatus 130 and the CAS device 120 are connected via a network 150. The CAS device 120 provides a storage device for archiving by the NAS device 102. The metadata conversion apparatus 130 and the client 140 are connected via a network 170. The client 140 includes one or a plurality of computers that utilize an object search service provided by the CAS device 120 and the metadata conversion apparatus 130.

The network 104 is a LAN within the site, the network 150 and the network 170 are LANs within the data center 110, and the network 160 is a WAN. The type of network is not limited to the above networks, and various types of networks may be utilized.

While in FIG. 1 the CAS device 120 and the metadata conversion apparatus 130 are illustrated as physically separate apparatus in the data center 110, other forms are possible. For example, the CAS device 130 may include the function provided by the metadata conversion apparatus 130. The CAS device 120 and the metadata conversion apparatus 130 may be disposed at separate locations. For example, the metadata conversion apparatus 130 may be provided in the NAS device 102.

The process outline will be described. In the NAS device 102, files and directories created and updated by the client 101 are stored in the file system 103. Generally, a file system includes a flag indicating whether, as inheritance information, an upper-level directory is being inherited so that the inheritance relationship can be known by referring to the flag. The dotted line arrows in the file system 103 indicate metadata inheritance relationship. For example, FIG. 1 shows that, because Dir_C inherits Dir_A and File_Z inherits Dir_C, File_Z inherits the metadata of Dir_A that is the upper-level directory. FIG. 1 also shows that because there is no inheritance relationship between Dir_B and Dir_A, File_X has an inheritance relationship only with Dir_B.

The CAS device 120 stores and manages files and directories archived by the NAS device 102 as objects in the name space 121. The name space 121 refers to a logically divided management unit of the CAS device 120 corresponding to the file system 103 of the NAS device 102. Namely, the name space 121 is provided and managed for each site. The CAS device 120 includes a search engine 124 and a metadata index 125 enabling a search of the objects stored in the name space 121. The metadata conversion apparatus 130 includes a search query process program 131, and provides an object search service to the client 140 in coordination with the search engine 124 of the CAS device 120.

FIG. 1 further illustrates how the NAS device 102 archives a file in the CAS device 120 and how the client 140 executes an object search from process (1) to process (6). In process (1), the NAS device 102 archives a file in the LAS device 120. At this time, when the archive target file has retained metadata inheriting the upper-level directory, the NAS device 102 causes the UUID of the CAS object corresponding to the inheritance source directory (upper-level directory) to be included in the metadata of the CAS object corresponding to the archive target file, thus transmitting the UUID to the CAS device 120. Thus, in the metadata of the CAS object Obj_X corresponding to File_X, the UUID of the CAS object Obj_B corresponding to the parent directory Dir_B inherited by the File_X is stored. In process (2), the search engine 124 updates the metadata index 125 on the basis of the updated object metadata.

In process (3), the client 140 of the data center 110 issues a search request query to the metadata conversion apparatus 130. The query may be issued not just by the client 140 but also by the client 101 of each site. This is because the processing of a search request and the process of determining whether a search result can be viewed and whether a search result file or directory may be accessed are different processes, as will be described below. In process (4), the search query process program 131, in coordination with the search engine 124, acquires a list of objects matching the query at process (3). If the objects are objects of the inheritance source, the search query process program 131 further acquires inheriting objects in process (5). In process (6), the search query process program 131 outputs a search result to the client 140.

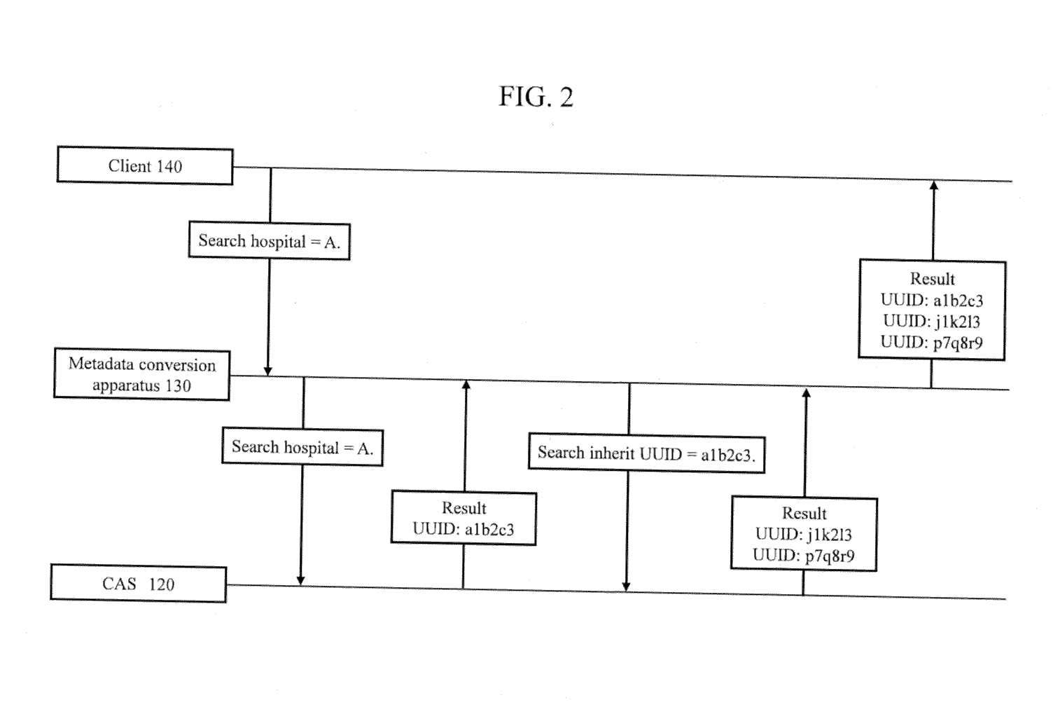

FIG. 2 illustrates an example of the search process. The client 140 requests objects with custom metadata matching “hospital=A” from the metadata conversion apparatus 130. This corresponds to process (3) of FIG. 1.

The metadata conversion apparatus 130 requests the objects matching “hospital=A” from the search engine 124 of the CAS device 120, and acquires “UUID: a1b2c3” as a result. Those processes correspond to FIG. 1 (4).

Thereafter, as it has been found that the object with the UUID of a1b2c3 is an inheritance source, the metadata conversion apparatus 130 requests from the search engine 124 “inherit UUID:a1b2c3 (directory or file inheriting metadata of UUID:a1b2c3)”, and acquires “UUID: j1k2l3” and “p7q8r9” as a result. These processes correspond to process (5) of FIG. 1.

Finally, the metadata conversion apparatus 130 merges the results of processes (4) and (5) and outputs them to the client 140 as a search result. This process corresponds to process (6) of FIG. 1.

As described above, the inheritance information of the metadata of the files and/or directories retained in the NAS device 102 is retained in the metadata each object in the CAS device 120. Then, the inheritance information is interpreted by the metadata conversion apparatus 130, enabling a search of the metadata of the objects stored in the CAS device 120. Further, the metadata conversion apparatus 130 can make an access permission determination by interpreting the ACL of the objects stored in the CAS device 120. Further, even when the inheritance source metadata is modified, it is only necessary to update the metadata of the CAS object corresponding to the directory, this mitigating an increase in I/O and network load.

### <Use Case Example of the Present Embodiment>

As a use case of the present embodiment, utilization of medical data in a medical information system may be considered. In the system, medical data generated in the site 100 (such as a hospital) is archived in the data center 110, and a data search is conducted in the data center 110. For medical images, a large volume of custom metadata is generated in accordance with a format such as Digital Imaging and COmmunication in Medicine (DICOM). The custom metadata of such medical images generated in large volumes include many common portions. Thus, by providing the inheritance function, redundancy in the custom metadata due to the copying of inheritance source access control information as in Patent Literature 1 can be eliminated. Accordingly, by applying the present invention to the medical information system, medical image search in the data center 110 can be realized while ensuring security.

### <Internal Configuration of NAS Device>

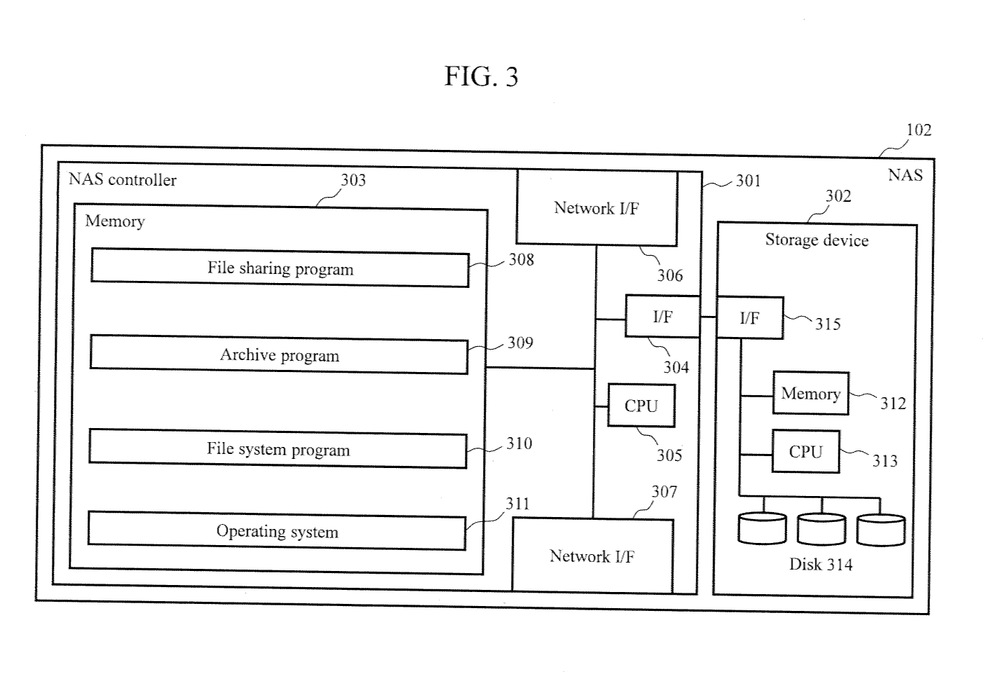

FIG. 3 is a block diagram of a hardware and software configuration example of the NAS device 102. The NAS device 102 includes a NAS controller 301 and a storage apparatus 302. The NAS controller 301 provides a file sharing service to the client 101, and stores various files created by the client 101 or file system constituent information in the recording apparatus 302. The NAS controller 301 also has the function of coordinating with the CAS device 120.

The recording apparatus 302 provides a volume to the NAS controller 301, providing a storage location for the various files and the file system constituent information stored by the NAS controller 301.

Further, the NAS controller 301 is provided with a CPU 305 that executes a program stored in the memory 303; a network interface 306 used for communication with the client 101 via the network 104; a network interface 307 used for communication with the data center 110 via the network 160; a storage interface 304 used for connection with the storage apparatus 302; and a memory 303 for storing programs and data. The various elements are mutually connected via a bus and the like.

The memory 303 stores a file sharing program 308, an archive program 309, a file system program 310, and an operating system 311. The programs stored in the memory 303 may be stored in the storage apparatus 302 and then read by the CPU 305 to the memory 303 for execution.

The file sharing program 308 is a program providing a means for the client 101 to perform a file operation on file data on the NAS device 102. The archive program 309 is a program for migrating file data from the NAS device 102 to the CAS device 120 for storage and recording. The file system program 310 is a program for controlling the file system 103 in the NAS device 102. The operating system 311 has, e.g., an input/output control function and a function for controlling a read or write to a storage apparatus, such as a disk or a memory, and includes a program for providing these functions to the other programs.

The storage apparatus 302 is provided with a storage interface 315 used for connection with the NAS controller 301; a CPU 313 that executes a command from the NAS controller 301; a memory 312 for storing programs and data; and one or a plurality of disks 314. These elements are mutually connected via a bus and the like. The storage apparatus 302 provides a storage function of block format, such as Fibre Channel Storage Area Network (FC-SAN), to the NAS controller 301.

### <Internal Configuration of CAS Device>

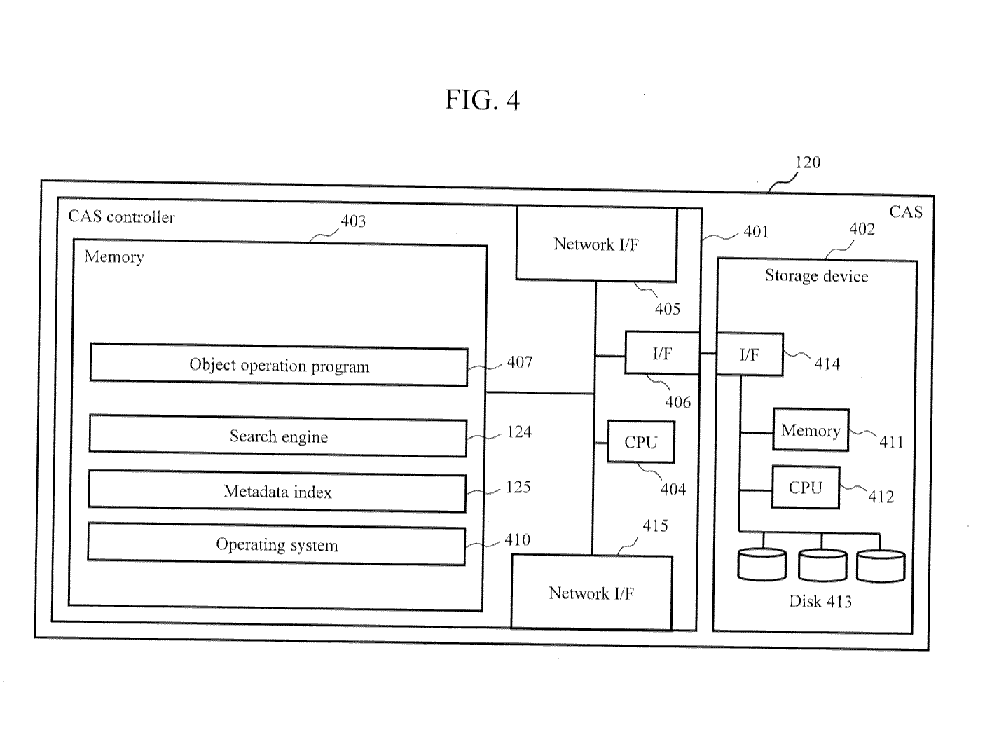

FIG. 4 is a block diagram of a hardware and software configuration example of the CAS device 120. The CAS device 120 includes a CAS controller 401 and a recording apparatus 402.

The CAS controller 401 is provided with a CPU 404 that executes a program stored in the memory 403; a network interface 405 used for communication with the NAS device 102 via the network 160; a network interface 415 used for communication with the metadata conversion apparatus 130 via the network 150; an interface 406 used for connection with the recording apparatus 402; and a memory 403 storing programs and data. These elements are mutually connected via an internal communication path (such as a bus).

The memory 403 stores an object operation program 407, the search engine 124, the metadata index 125, and an operating system 410. These programs may be stored in the recording apparatus 402 and then read by the CPU 404 to the memory 403 for execution.

The object operation program 407 is a program providing a means for the NAS device 102 to perform an operation on an object on the CAS device 120. The search engine 124 is a program providing the client 140 with a service for searching the objects stored in the CAS device 120. The metadata index 125 is a metadata index created by the search engine 124. The operating system 410 is similar to the operating system 311.

The recording apparatus 402 is provided with an interface 414 used for connection with the CAS controller 401; a CPU 412 that executes a command from the CAS controller 401; a memory 411 storing programs and data; and one or a plurality of disks 413. These elements are mutually connected via an internal communication path (such as a bus). The recording apparatus 402 provides the CAS controller 401 with a storage function of block format, such as FC-SAN.

### <Internal Configuration of Metadata Conversion Apparatus>

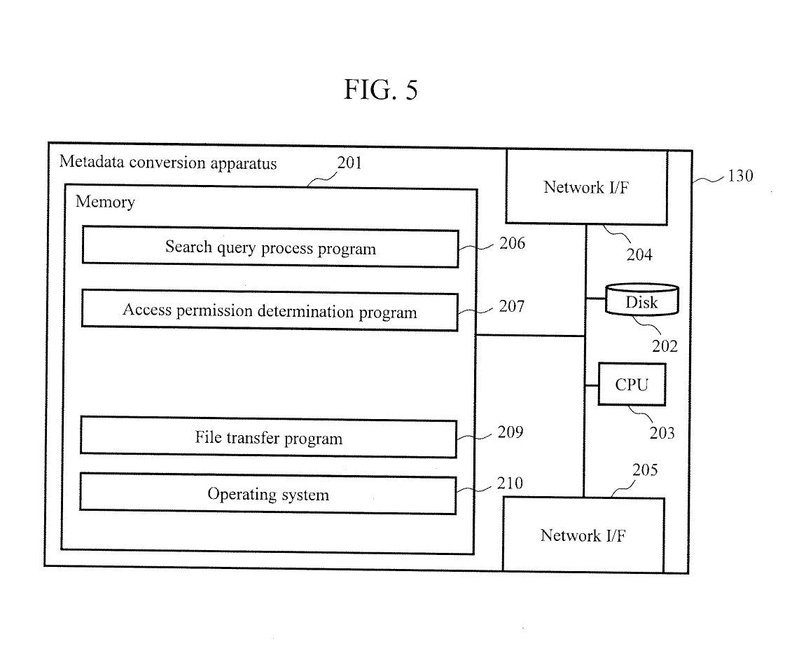

FIG. 5 is a block diagram of a hardware and software configuration example of the metadata conversion apparatus 130. When the custom metadata is “inherit”, it is necessary to acquire the metadata itself of the inheritance source. At this time, a process of converting the inheritance source UUID into inheritance source custom metadata is executed. Thus, according to the present embodiment, the apparatus illustrated in FIG. 5 is referred to as the metadata conversion apparatus.

The metadata conversion apparatus 130 is provided with a memory 201 that stores programs and data; a disk 202 that stores programs and data; a CPU 203 that executes the programs stored in the memory 201 or the disk 202; a network interface 204 used for communication with the NAS device 102 of the site 100 via the network 160; and a network interface 205 used for communication with the CAS device 120 via the network 150. These elements are mutually connected via an internal communication path (such as a bus) and the like.

The memory 201 stores a search query process program 206, an access permission determination program 207, a file transfer program 209, and an operating system 210. The programs or tables stored in the may be stored in the disk 207 and read by the CPU 203 to the memory 201 for execution.

The search query process program 206 is a program providing the client 140 with a search service. The access permission determination program 207 is a program for determining the access permission of an access-requested object on the basis of the access control list (ACL). The file transfer program 209 is a program for acquiring an access-requested object from the CAS device 120 and transferring the object to a request source. The operating system 210 is similar to the operating system 311.

### <Metadata Configuration in File System of NAS Device>

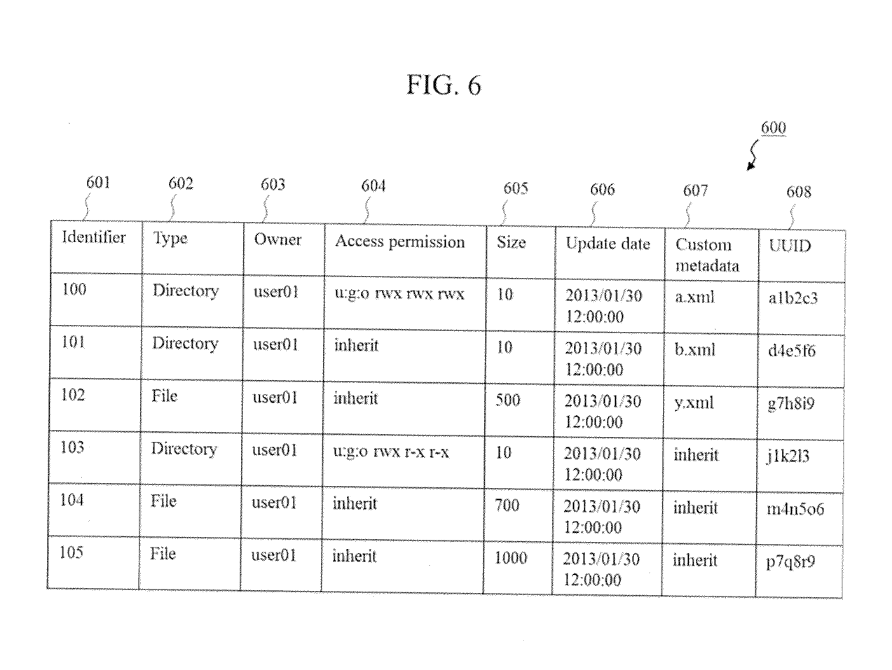

FIG. 6 illustrates a configuration example of the metadata of a file stored in the file system 103 of the NAS device 102. The metadata 600 of the file includes an identifier 601, a type 602, an owner 603, an access permission 604, a size 605, an update date 606, a custom metadata 607, and a UUID 608 as constituent information.

The identifier 601 is a value uniquely identifying the file stored by the file system program 310 in the file system 103. The type 602 indicates whether the file type is directory or file. The type may include, other than directory and file, special files such as symbolic link and socket. The owner 603 indicates the owner of the file. In addition to the owner 603, an owner group and the like may be provided.

The access permission 604 includes ACL information for determining an access to a file, and indicates the determination target such as a user or a group, and the operation (such as read, write, or execute) permitted or prohibited for the determination target. In the access permission 604, “u:g:o rwx rwx rwx” indicates that u (owner), g (group), and o (others) have the permission to read (r), write (w), and execute (x) with regard to the directory. In the access permission 604, “inherit” indicates that the file inherits the access permission of the upper-level directory. Further, in the access permission 604, “u:g:o rwx r-x r-x” indicates that while u (owner) has all of the permissions to read (r) write (w) and execute (x) with regard to the directory g (group) and o (others) only have the permission to read (r) and execute (x) the file.

The size 605 indicates the file size. The update date 606 indicates the time of the last write to the file. Other than the update date 606, there may be provided time stamps for the final access date, the final modify date, or date of generation, for example.

The custom metadata 607 indicates metadata defined by the client 101. For example, the custom metadata of the file of the identifier 100 is indicated to be stored in a separate file “a.xml”. In the custom metadata 607, “inherit” indicates that the file inherits the custom metadata of the upper-level directory. The UUID 608 indicates the UUID of the CAS object corresponding to the file. The UUID 608 is allocated to each file on the NAS device 102 or the data center 110 (CAS device 120). When the UUID is allocated on the CAS 120, the CAS 120 notifies the NAS 102 of the UUID of the relevant file.

In FIG. 5, the “inherit” in the access permission 604 or the custom metadata 607 does not indicate which directory is inherited as information. However, it can be known which is being inherited because the tree structure is known in the file system.

### <Metadata Configuration in CAS Device>

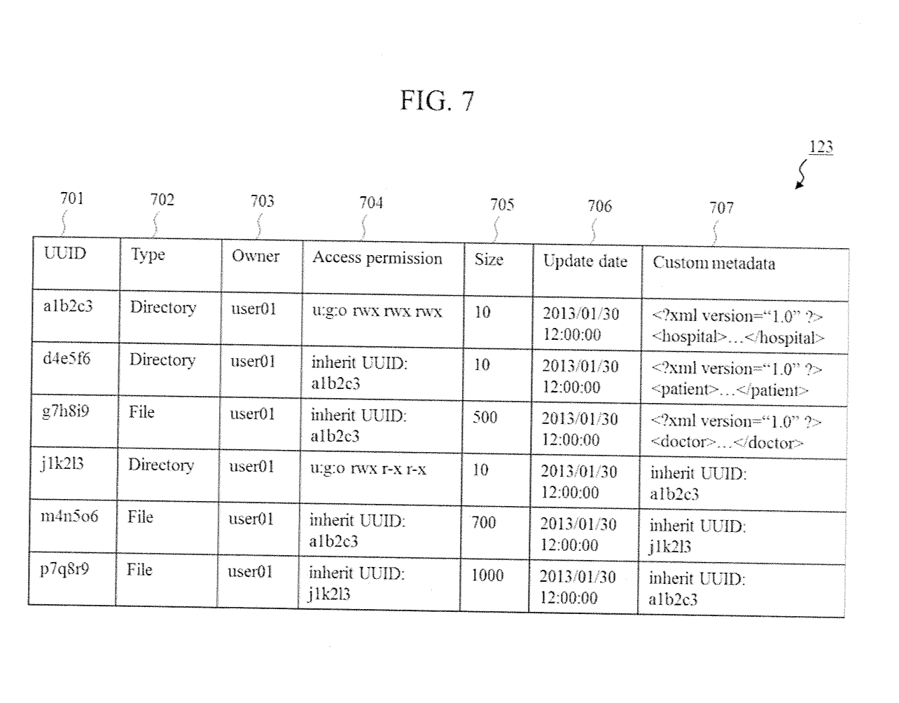

FIG. 7 illustrates a configuration example of the metadata of an object stored in the name space 121 of the CAS device 120. The object metadata includes a UUID 701, a type 702, an owner 703, an access permission 704, a size 705, an update date 706, and a custom metadata 707 as constituent information.

The UUID 701 is the same information as the UUID 604 of FIG. 6. The type 702 is the same information as the type 602 of FIG. 6. The owner 703 is the same information as the owner 603 of FIG. 6.

In the access permission 704, which is the same information as the access permission 604 of FIG. 6, the UUID of an inheritance source object is stored when the access permission is inherited.

The size 705 is the same information as the size 605 of FIG. 6. The update date 706 is the same information as the update date 606 of FIG. 6.

In the custom metadata 707, which is the same information as the custom metadata 607 of FIG. 6, the content of custom metadata is stored. When the custom metadata is inherited, the UUID of the inheritance source object is stored. When the custom data 707 of a directory retains the content of the metadata without including the inheriting UUID (inherit UUID), it can be known that the directory is an inheritance source directory or may constitute an inheritance source directory. Also, when the inheritance source is not included as a file, unique custom metadata is retained (such as the file of g7h8i9).

### <Configuration of Directory Object>

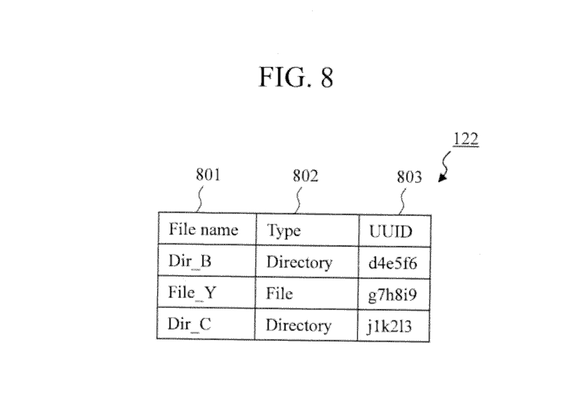

FIG. 8 illustrates a configuration example of the directory objects stored in the name space 121 of the CAS device 120. A directory object 122 includes a file name 801, a type 802, and a UUID 803 as constituent information. FIG. 8 shows the directory object corresponding to Dir_A of FIG. 1, and information of Dir_B, File_Y, and Dir_C are stored in the directory object.

The file name 801 is information indicating the file name used when the client 101 accesses a file. The type 802 is the same information as the type 602 of FIG. 6. The UUID 803 is the same information as the UUID 608 of FIG. 6.

While not illustrated in the drawing, in the directory object of Dir_B, the information of File_X is stored, so that the tree structure of the file system 103 can be restored by tracing the directory objects from the upper-level, thus realizing restoration on a directory unit basis.

### <Archiving Process>

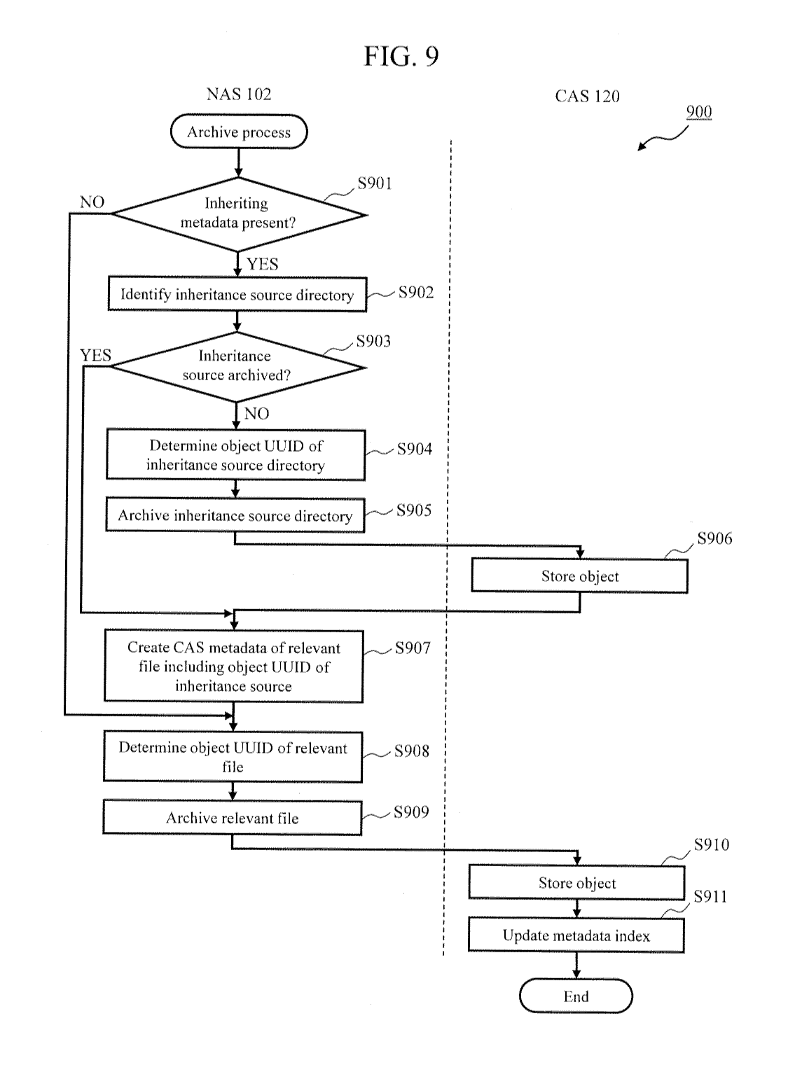

FIG. 9 is a flow chart illustrating an archiving process by the NAS device 102. The archiving process is a process called from the operating system 311 at archiving periods or timing set by an administrator, for transferring to the CAS device 120 one or more of the files stored in the NAS device 102 that satisfy archiving conditions set by the administrator as will be described below.

(i) Step S901: The archive program 309 of the NAS device 102 determines whether, with respect to a file and/or directory in the files stored in the file system 103 that satisfies the archiving conditions set by the administrator, there is inherited metadata (metadata of inheritance source directory). Whether there is the inheritance source directory is determined by referring to the custom metadata 607 and the access permission 603 of FIG. 6. If there is the inherited metadata (step S901: YES), the process moves to step S902. If there is not the inherited metadata (step S901: NO), the process moves to step S908.

(ii) Step S902: The archive program 309 refers to the custom metadata 607 and/or the access permission 603 of FIG. 6, and identities the inheritance source upper-level directory. If a plurality of metadata are inherited and each has a different inheritance source, the inheritance source upper-level directory is identified for each.

(iii) Step S903: The archive program 309 determines whether the directory identified in step S902 is already archived in the CAS device 120. If already archived (step S903: YES), the process moves to step S907. If not archived yet (S903: NO), the process moves to step S904.

(iv) Step S904: The archive program 309 determines the object UUID of the inheritance source directory.

(v) Step S905: The archive program 309 makes an inheritance source directory archiving request to the CAS device 120.

(vi) Step S906: In response to the archiving request, the CAS device 120 stores the data received from the NAS device 102 in an entry corresponding to the UUID 701 for which an object has been designated.

(vii) Step S907: The archive program 309 creates metadata that includes the UUID of the inheritance source of the metadata inherited by the archive target file and that is to be transferred to the CAS device 120. When a plurality of metadata (such as the access permission 604 and the custom metadata 608) inherit a directory and each has a different inheritance source, the UUID of each inheritance source is included.

(viii) Step S908: The archive program 309 determines the object UUID of the relevant file.

(ix) Step S909: The archive program 309 makes an archiving request for the relevant file from CAS device 120.

(x) Step S910: In response to the archiving request, the CAS device 120 stores the data received from the NAS device 102 in the UUID for which the object has been designated.

(xi) Step S911: The CAS device 120 updates the metadata index 125 using the metadata added in step S910.

(xii) Archiving process timing and condition: According to the present embodiment, the archiving process is called from the operating system 311 at the migration periods or timing set by the administrator. However, the archiving process for a file may be performed at the timing of finding the file satisfying the archiving conditions.

The archiving conditions set by the administrator may include, for example, AND or OR conditions of the file owner, the date of file creation, the date of final file update, the date of final file access, file, size, file type, the presence or absence of Write Once Read Many (WORM) setting, the presence or absence of retention setting and its period. The archiving conditions may be set for the file system 103 as a whole, or individually for specific directories or files. When a file that is once archived is recalled and then stored in the file system 103, the file again provides a migration process target upon occurrence of an update in the file data. In this case, the presence or absence of an update in the recalled file may be determined by the NAS device 102 by the following method. For example, “the presence or absence of write after a recall” is stored in the attribute information of the files, and the files are managed such that only the files with a raised flag are considered the archive targets. In another method, the file attribute information may be provided with a field for storing “recall date”, and the recall date may be compared with the final update date of a file for the determination. In still another method, when there is a write request for a recalled file, the archiving process may be performed at the timing of the end of response to the write request.

(xiii) UUID determination: In FIG. 9, the NAS device 102 determines the UUID of the archive target file in step S904 and step S908. However, the target of UUID determination is not limited to this. For example, the UUID may be determined by the CAS device 120 in accordance with a request from the NAS device 102. When there is a number of devices connected to the CAS device 120, the possibility of UUID collision increases if each device makes UUID determination. In this case, it is more useful to determine the UUID by the CAS device 120. However, in this case, the determined UUID is notified to the NAS device 102.

### <Search Process>

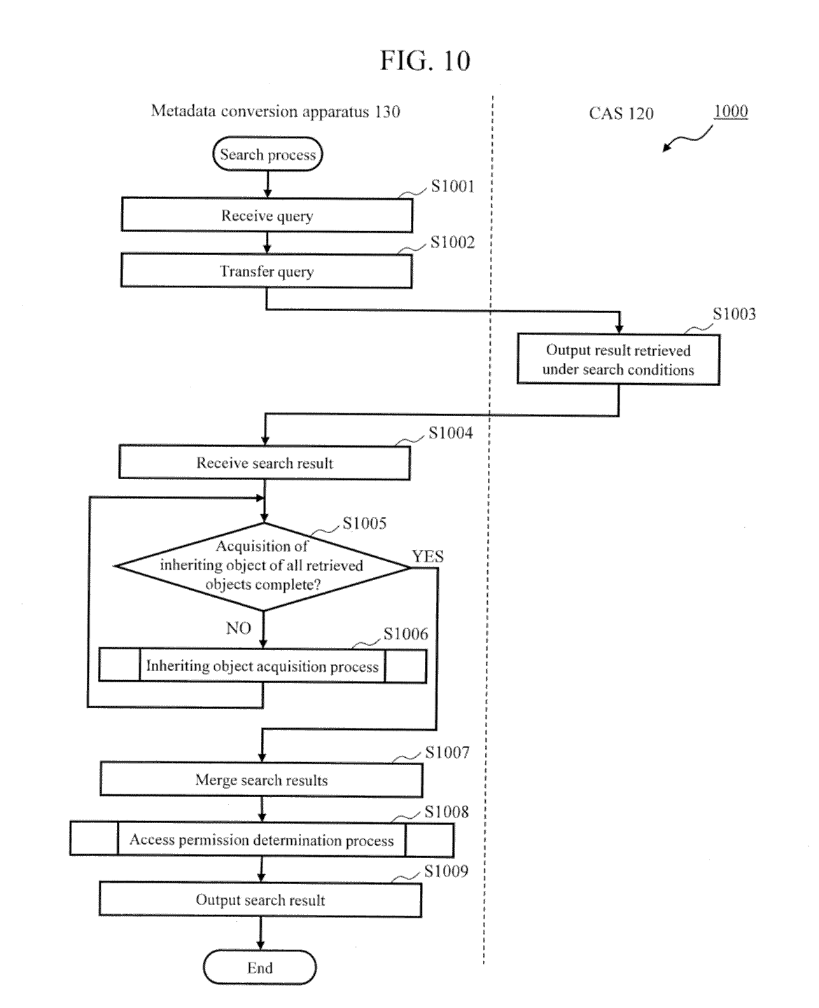

FIG. 10 is a flow chart illustrating the search process in the data center 110 according to the first embodiment. The search process is called upon search request from the client 140, for example.

(i) Step S1001: The search query process program 206 of the metadata conversion apparatus 130 receives a search request from the client 140.

(ii) Step S1002: The search query process program 206 transfers the search query received in step S1001 to the search engine 124 of the CAS device 120.

(iii) Step S1003: The search engine 124 of the CAS device 120 extracts objects matching the search query with reference to the metadata index 125, and outputs the objects as the result.

(iv) S1004: The search query process program 206 receives the result of step S1003.

(v) Step S1005: The search query process program 206 determines whether the inheriting objects of all of the objects in the result received in step S1004 (all files and directories that inherit the directory (inheritance source) of the search result) have been acquired. If not acquired (step S1005: NO), the process moves to step S1006. If acquired (step S1005: YES), the process moves to step S1007.

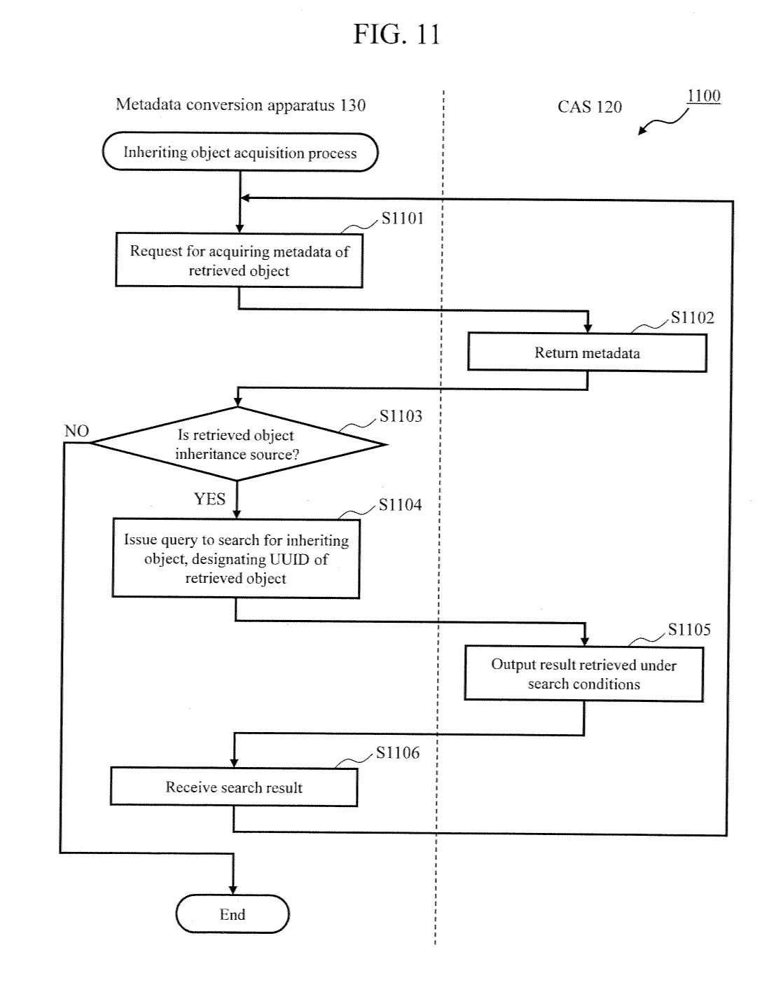

(vi) Step S1006: The search query process program 206 executes an inheriting object acquisition process which will be described later with reference to FIG. 11. After the inheriting object process is executed, the process moves to step S1005.

(vii) Step S1007: The search query process program 206 merges the results of steps S1004 and S1006.

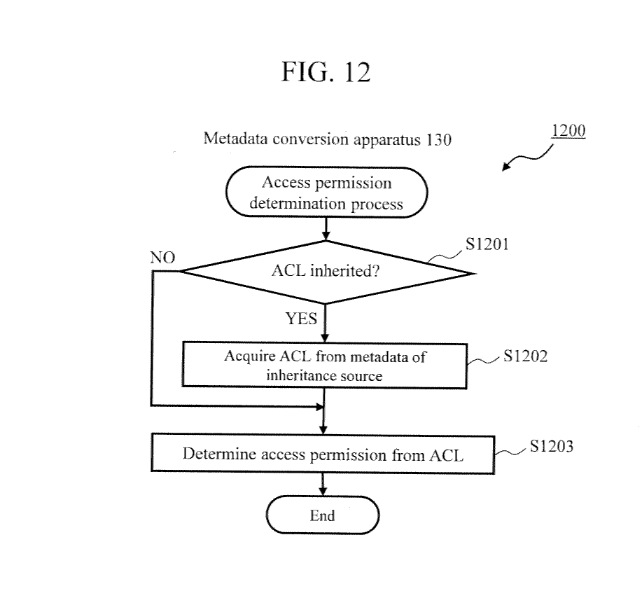

(viii) Step S1008: The access permission determination program are 207 executes an access permission determination process which will be described later with reference to FIG. 12.

(ix) Step S1009: The search query process program 206 returns to the client 140 those of the results of step S1007 that were determined to have access permission step S1008.

In FIG. 10, the metadata conversion apparatus 130 and the CAS device 120 communicate each other via the network 150. However, when the metadata conversion apparatus 130 is included in the CAS device 120, no communication via a network may be generated.

### <Inheriting Object Acquisition Process>

FIG. 11 is a flow chart illustrating the inheriting object acquisition process. The inheriting object acquisition process is a process corresponding to step S1006 of FIG. 10, where objects that inherit the objects retrieved by a search are acquired.

(i) Step S1101: The search query process program 206 of the metadata conversion apparatus 130 delivers to the CAS device 120 a request for acquiring the metadata of the objects retrieved by the search.

(ii) Step S1102: The CAS device 120 receives the metadata acquisition request from the metadata conversion apparatus 130, and transfers the object metadata to the metadata conversion apparatus 130.

(iii) Step S1103: The search query process program 206 of the metadata conversion apparatus 130 receives the object metadata from the CAS device 120, and determines whether the object is an inheritance source with reference to the metadata 123 of FIG. 7. The metadata 123 of FIG. 7 may be provided with information indicating whether each object is an inheritance source. In this case, the determination as to whether the object is an inheritance source may be performed on the basis of the newly added information. When the object is an inheritance source (step S1103: YES), the process transitions to step S1104. If not an inheritance source (step S1103: NO), the process ends the inheriting object acquisition process.

(iv) Step S1104: The search query process program 206 designates the UUID of the object retrieved by the search, and requests the search engine 124 of the CAS device 120 to conduct a search for objects that inherit the object.

(v) Step S1105: The search engine 124 of the CAS device 120 extracts the object matching the search query with reference to the metadata index 410, and outputs the object as a result.

(vi) Step S1106: The search query process program 206 receives the result of step S1105, and causes the process to transition to step S1101. Then, in step S1106, the process of step S1101 and thereafter is executed for the received result.

The inheriting object of the result obtained in step S1106 of FIG. 11 is further acquired because the object may be inherited in multiple stages.

### <Access Permission Determination Process>

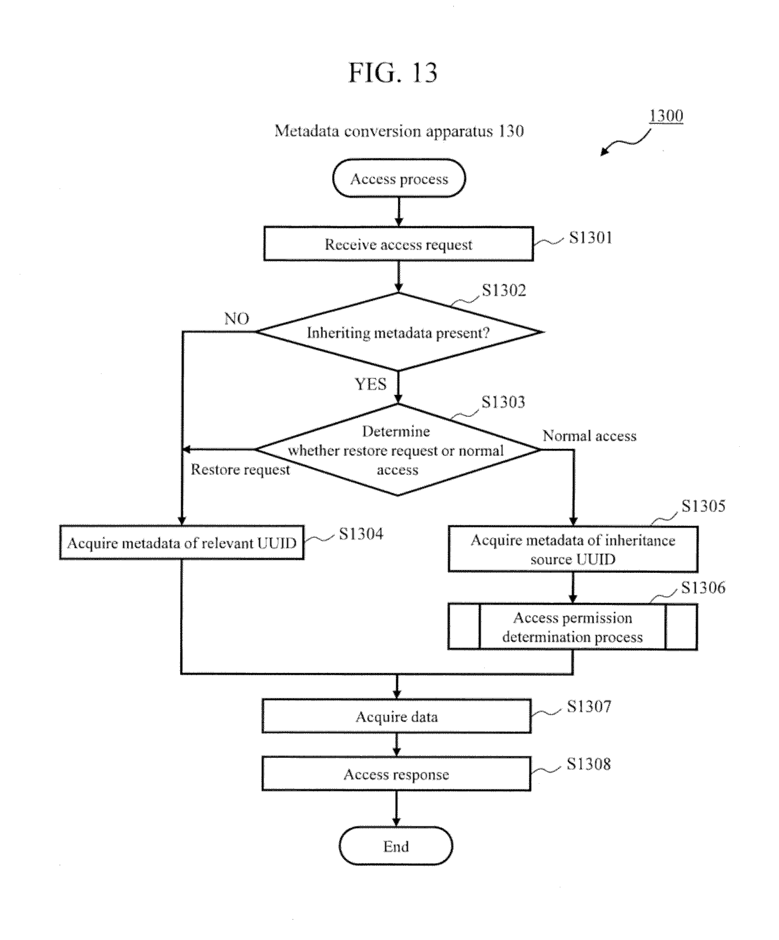

FIG. 12 is a flow chart illustrating the access permission determination process by the access permission determination program 207 of the metadata conversion apparatus 130. The access permission determination process is a process corresponding to step S1008 of FIG. 10 and step S1306 of FIG. 13, which will be described later, for determining the access permission on the basis of access control information. The access permission determination process makes it possible to conceal the presence if a file when, for example, the file name itself constitutes security information.

(i) Step S1201: The access permission determination program 207 refers to the object metadata (the access permission 704 of FIG. 7) and determines whether the ACL is inherited. If the ACL is inherited (step S1201: YES), the process transitions to step S1202. If the ACL is not inherited (step S1201: NO), the process transitions to step S1203.

(ii) Step S1202: The access permission determination program 207, on the basis of the UUID of the inheritance source object stored in the object metadata, acquires the inheritance source metadata (access permission 704) from the CAS device 120.

(iii) Step S1203: The access permission determination program 207 determines the access permission on the basis of the ACL of the object.

By acquiring the body of ACL from the inheritance source UUID in accordance with FIG. 12, the determination of access permission can be realized in the data center 110. In FIG. 12, the access permission determination is made by the metadata conversion apparatus 130 in step S1203. However, the agent of the access permission determination is not limited to the metadata conversion apparatus 130. For example, the determination may be made by an externally connected search appliance or the NAS device 10.

### <Access Process>

FIG. 13 is a flow chart illustrating the access process to a specific object stored in the CAS device 120. The access source NAS device 102, the client 140, or an external terminal (such as a wireless portable terminal) designates the UUID of a requested object, and designates whether the metadata stored in the CAS device 120 is to be acquired as is or, if inherited, the body of metadata is to be acquired from the inheritance source. The case in which the metadata stored in the CAS device 120 is acquired as is is the case in which a the is restored in the NAS device 102.

(i) Step S1301: The file transfer program 209 of the metadata conversion apparatus 130 receives an access request from the NAS device 102 or the client 140 and the like.

(ii) Step S1302: The file transfer program 209 determines whether the object of the requested access target includes inheriting metadata (whether there is metadata of an object of the inheritance source that the relevant object itself is inheriting). If the inheriting metadata is included (step S1302: YES), the process transitions to step S1303. If the inheriting metadata is not included (step S1302: NO), the process transitions to step S1304.

(iii) Step S1303: The file transfer program 209 determines whether the requested access is a restore request or a normal access. The restore request is issued from the NAS device 102, while the normal access request is issued from the NAS device 102, the client 140, or the like. In the case of a restore request (step S1303: Restore request), the process transitions to step S1304. In the case of a normal access request (step S1303: Normal access), the process transitions to step S1305.

(iv) Step S1304: In the case of restore request, the file transfer program 209 acquires the metadata of the requested object from the CAS device 120. Because the NAS device 102 is informed of the file directory structure and the inheritance relationship of each file, it is only necessary in this step to know whether the target object (file) inherits the upper-level object (directory).

(v) Step S1305: In the case of normal access request, the file transfer program 209 acquires the metadata of the inheritance source UUID.

(vi) Step S1306: The access permission determination program 207 executes the access permission determination process of FIG. 12. Because in the case of a restore request, the access permission determination is performed in the NAS 102, the access permission determination process is not performed in the metadata conversion apparatus 130.

(vii) Step S1307: The file transfer program 209 acquires the data of the requested object.

(viii) Step S1308: The file transfer program 209 responds to the access source NAS device 102 or client 140 and the like.

### <Renaming Process>

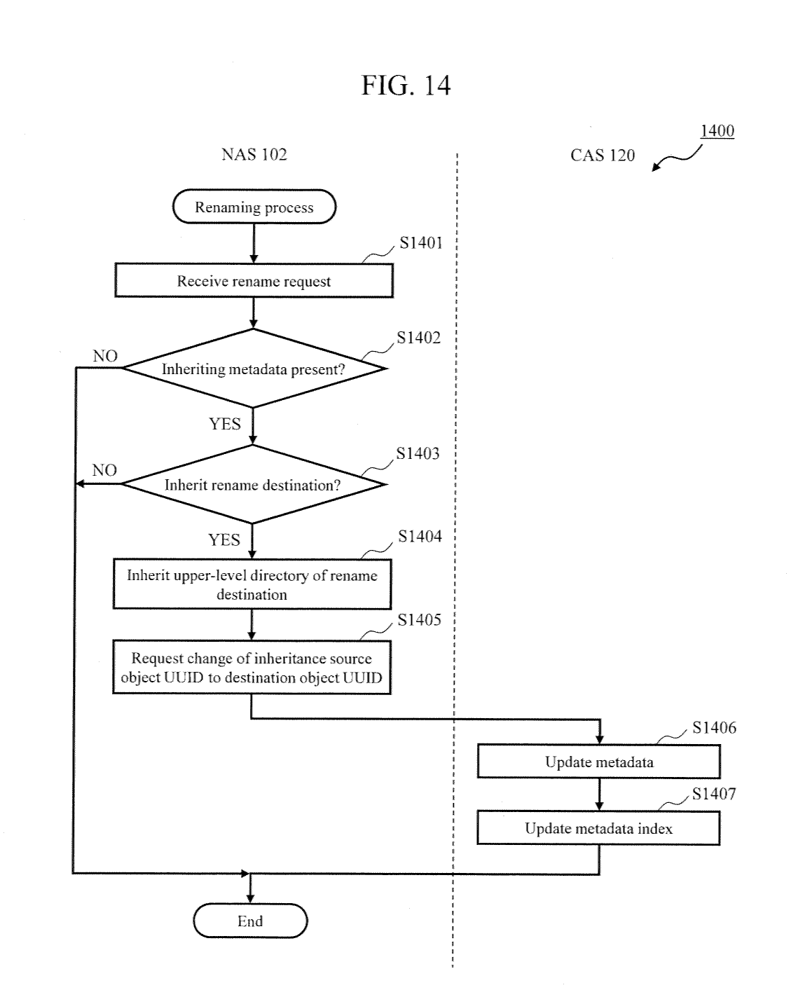

FIG. 14 is a flow chart illustrating a renaming process. The renaming process includes both a process of modifying a file name and/or a directory name themselves, and a process of moving files between directories (such as when File_X is moved from under Dir_B to under Dir_C). In the process of FIG. 14, the latter is more emphasized.

(i) Step S1401: The file sharing program 308 of the NAS device 102 receives a rename request from the client 101.

(ii) Step S1402: The file system program 310 determines whether there is metadata inherited by the rename target file (i.e., whether there is the metadata of an inheritance source directory). If there is the inherited metadata (step S1402: YES), the process transitions to step S1403. If the inherited metadata is not present (step S1402: NO), the renaming process ends.

(iii) Step S1403: The file system program 310 determines whether a renaming rule is set so as to inherit the upper-level directory of a renaming destination. In the NAS device 102, there is a predetermined rule as to whether, when a file is moved between directories the metadata of a renaming source is to be taken over or the metadata of a renaming destination is to be newly taken over. If the rule is set so as to inherit the upper-level directory of the renaming destination (step S1403: YES), the process transitions to step S1404. If the rule is not set so as to inherit the upper-level directory of the renaming destination (step S1404: NO), the renaming process ends.

(iv) Step S1404: The file system program 310 modifies the inheritance source of the file to the upper-level directory of the renaming destination.

(v) Step S1405: The file system program 310 requests the CAS device 120 to modify the inheritance source object UUID to the destination object UUID.

(vi) Step S1406: The object operation program 407 of the CAS device 120 updates the metadata received from the NAS device 102.

(vii) Step S1407: The CAS device 120 updates the metadata index using the metadata updated in step S1406.

### <Conclusion of the First Embodiment>

As described above, according to the first embodiment, with respect to a file and directory inheriting the upper-level directory metadata, the UUID of the object of the CAS device corresponding to the inheritance source directory is allocated to the metadata of the object of the CAS device corresponding to the file and directory as inheritance information. Then, the metadata conversion apparatus 130 interprets the inheritance information. In this way, it becomes possible to search the metadata of objects stored in the CAS device 120. Further, the metadata conversion apparatus 130 can make the access permission determination by interpreting the ACL of the object stored in the CAS device 120. Even when the inheritance source metadata is modified, it is only necessary to update the metadata of the CAS object corresponding to the relevant directory, whereby an increase in I/O and an increase in network load can be mitigated.

### (2) Second Embodiment

In the following, a second embodiment will be described. The following descriptions will be focused mainly on differences from the first embodiment while omitting or simplifying the description of common points to the first embodiment.

In the first embodiment, with respect to a file and directory inheriting the upper-level directory metadata, the UUID of the object of the CAS device corresponding to the inheritance source directory is allocated to the metadata of the object of the CAS device corresponding to the file and directory as inheritance information. On the other hand, according to the second embodiment, a directory object corresponding to an upper-level directory is provided with a flag indicating whether the subordinate files and directories inherit the metadata, thus storing inheritance information in the CAS device 120.

### <Configuration Example of Directory Object>

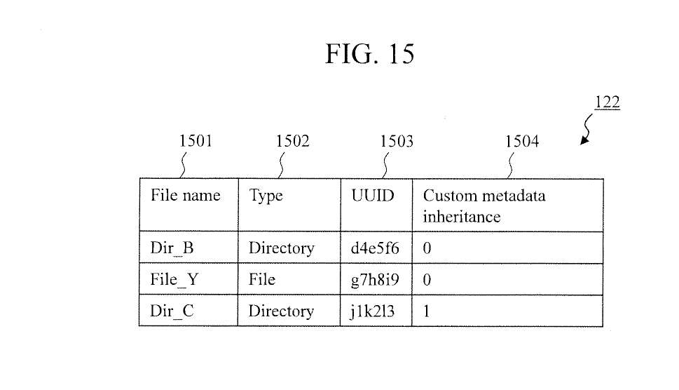

FIG. 15 illustrates a configuration example of a directory object stored in the name space 121 of the CAS device 120 according to the second embodiment. The directory object includes a file name 801, a type 802, a UUID 803, and custom metadata inheritance 804 as constituent information. FIG. 15 illustrates the directory object corresponding to Dir_A, storing information of Dir_B, File_Y, and Dir_C in the directory object.

In FIG. 15, the file name 1501, the type 1502, and the UUID 1503 the same information as the file name 801, the type 802, and the UUID 803, respectively. Meanwhile, the custom metadata inheritance 1504 is information indicating whether the file inherits the upper-level directory. For example, Dir_B and File_Y are 0, indicating that the custom metadata of these files do not inherit the metadata Dir_A. On the other hand. Dir_C is 1, indicating that the custom metadata inherits the metadata of Dir_A. While not illustrated in the drawing, the directory object of Dir_C is stored in File_Z. The custom metadata inheritance 1504 is 1, indicating that the metadata of Dir_C is inherited. As a result (i.e., because Dir_C inherits Dir_A, and File_Z inherits Dir_C), it is shown that the custom metadata of File_Z inherits the metadata of the upper-level directory Dir_A in which the substance of the custom metadata is stored. The custom metadata inheritance 1504 is allocated with reference to the custom metadata 607 of the subordinate files and directories of a directories when the archive program 309 of the NAS device 102 archives the directory in the archiving process.

### <Inheriting Object Acquisition Process>

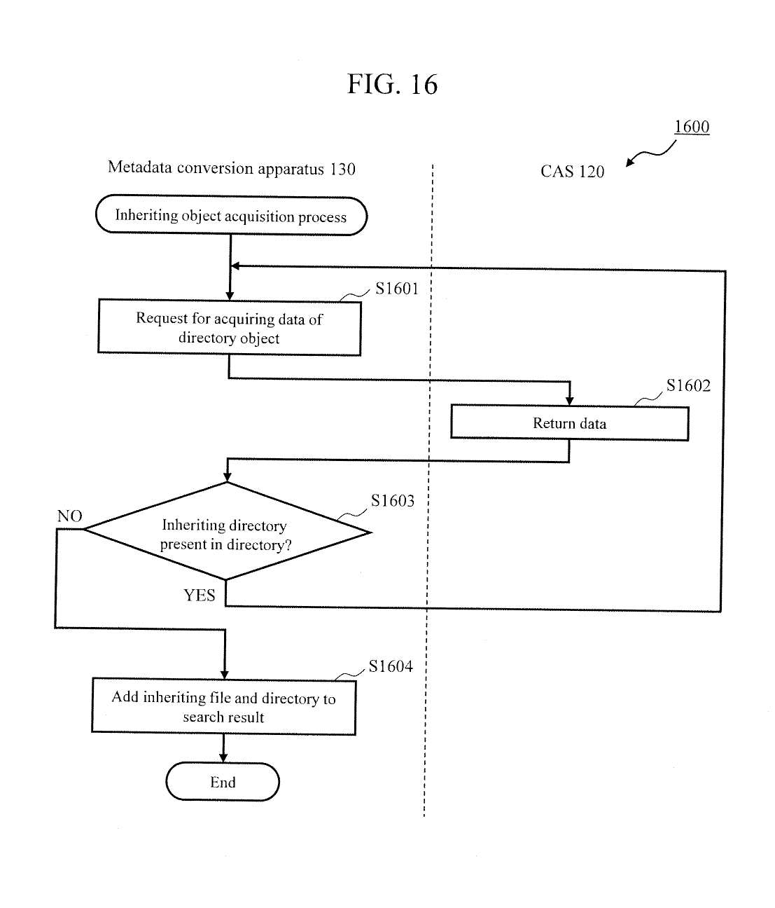

FIG. 16 is a flow chart illustrating the inheriting object acquisition process according to the second embodiment. The inheriting object acquisition process corresponds to the process of step S1006 of FIG. 10, and is a process of acquiring an object inheriting an object retrieved by a search.

(i) Step S1601: The search query process program 206 of the metadata conversion apparatus 130 delivers to the CAS device 120 a request for acquiring the data of the objects retrieved by the search.

(ii) Step S1602: The CAS device 120 receives the data acquisition request from the metadata conversion apparatus 130, and transfers the data of the objects to the metadata conversion apparatus 130.

(iii) Step S1603: The search query process program 206 of the metadata conversion apparatus 130 receives the data of the objects from the CAS device 120, and, with reference to the director object of FIG. 15, determines whether there is a directory in the directories that inherits the relevant directory. If there is the directory that inherits the relevant directory (step S1603: YES), the process transitions to step S1601. Then, the search query process program 206 performs the process S1601 and thereafter with respect to the directory inheriting the relevant directory. If there is no inheritance source (step S1603: NO), the process transitions to step S1604.

(iv) Step S1604: The search query process program 206 adds the inheriting files and directories to the search result.

### <Conclusion of the Second Embodiment>

As described above, according to the second embodiment, the directory object corresponding to the upper-level directory is provided with information indicating whether the subordinate files and directories inherit the metadata, thereby enabling a search of the metadata of the object stored in the CAS device 120 with higher efficiency.

### (3) Other

Because the present embodiment cart be realized by the addition of functions to the conventional technology by software, there is no need for the addition of infrastructure. Because communications between the sites are not required, there is no need for adding communication infrastructure between the sites for data sharing. Further, the utilized backup data may be provided by the backup data acquired for recovery at the time of the accident/failure, there is no need for adding storage at a data center.

The present embodiment may be realized by a software program code for realizing the functions of the embodiments. In this case, a storage medium in which the program code is recorded may be provided to a system or an apparatus, and a computer (or a CPU or a MPU) in the system or apparatus may be configured to read the program code stored in the storage medium. In this case, the functions of the embodiments may be realized by the program code itself read from the storage medium, so that the program code itself, or the storage medium storing the code may constitute the present embodiment. Examples of the storage medium for supplying such program code include a flexible disc, a CD-ROM, a DVD-ROM, a hard disk, an optical disk, magnetooptical disk, a CD-R, a magnetic tape, a non-volatile memory card, and a ROM.

Based on instructions of the program code, some or all of the actual processes may be performed by an operating system (OS) and the like running on the computer so that the functions of the embodiments can be realized by the processes. Further, after the program code read from the storage medium is written to a memory in the computer, some or all of the actual processes may be performed by the CPU and the like of the computer on the basis of the instructions of the program code, so that the functions of the embodiments can be realized by the processes.

The software program code for realizing the functions of the embodiments may be delivered via a network and then stored in a storage means of the system or apparatus, such as a hard disk or a memory, or in a storage medium such as a CD-RW or a CD-R. The program code stored in the storage means or the storage medium may be read and executed by the computer (or the CPU or MPU) of the system or apparatus during use.

Finally, it should be understood that the above-described processes and technologies are not associated with any specific apparatus substantially and may be implemented by any appropriate combination of components. Further, various types of devices for general purposes may be used in accordance with the teaching that has been described herein. It may be realized that the method steps described herein may be beneficially executed by constructing a dedicated apparatus. While the present embodiments have been described with reference to specific examples, these are in every respect for illustrative purposes only and not for limitation. Those skilled in the art may realize that there is a number of combinations of hardware, software, and firmware suitable for implementing the present invention. For example, the described software may be implemented by a wide range of programs or script languages, such as assembler, C/C++, perl, Shell, PHP, or Java (registered trademark).

In addition, other implementations of the present invention may become apparent to those with knowledge of the relevant art upon review of the herein disclosed specification and embodiment of the present invention. Various forms and/or components of the described embodiments may be used either individually or in various combinations in a computerized storage system with data managing functions.

### REFERENCE SIGNS LIST

10 Computer system
100 Site
101 Client
102 NAS device (data providing computer)
103 File system
110 Data center
120 CAS device
121 Name space
130 Metadata conversion apparatus
140 Client

1. A computer system comprising:
at least one data providing computer; and
a data management computer system connected to the data providing computer,
wherein:
the data providing computer is a computer providing a user with data;
the data management computer system stores and manages data migrated from the data providing computer; and
the data providing computer, when metadata of data to be migrated to the data management computer system inherits metadata of an upper-level directory, causes address information for identifying the upper-level directory to be included in the metadata of the data to be migrated, and transmits the data to be migrated including the metadata including the address information to the data management computer system.

2. The computer system according to claim 1, further comprising a metadata conversion apparatus that interprets the address information included in the metadata of the data migrated to the data management computer system, the address information being of an inheritance source directory the metadata of which the migrated data inherits, and that acquires the inheritance source metadata,
wherein the metadata conversion apparatus, in response to a data search request, acquires data corresponding to the search request, acquires data inheriting, as an inheritance source, the metadata of the directory corresponding to the search request based on the address information, and outputs the data.

3. The computer system according to claim 1, further comprising a metadata conversion apparatus that interprets the address information included in the metadata of the data migrated to the data management computer system, the address information being of an inheritance source directory the metadata of which the migrated data inherits, and that acquires the inheritance source metadata,
wherein the metadata conversion apparatus, on the basis of access permission information of the inheritance source directory inherited by data to be output, determines the presence or absence of access permission of the data to be output.

4. The computer system according to claim 1, further comprising a metadata conversion apparatus that interprets the address information included in the metadata of the data migrated to the data management computer system, the address information being of an inheritance source directory the metadata of which the migrated data inherits, and that acquires the inheritance source metadata,
wherein:
the metadata conversion apparatus, in response to a data access request, determines whether the access request is a restore request or a normal access request; and
the metadata conversion apparatus acquires the metadata of target data of the access request in the case of a restore request, or acquires the metadata of the inheritance source directory inherited by the target data of the access request in the ease of a normal access request.

5. The computer system according to claim 1, wherein the data providing computer, in response to a data rename request, modifies the address information of an inheritance source directory the metadata of which target data of the rename request inherits.

6. The computer system according to claim 1, further comprising a metadata conversion apparatus that interprets the address information included in the metadata of the data migrated to the data management computer system, the address information being of an inheritance source directory the metadata of which the migrated data inherits, and that acquires the inheritance source metadata,
wherein:
the data management computer system with respect to each directory object, manages data provided at a lower level of each directory, and inheritance information indicating whether the lower-level data inherits the metadata of the upper-level directory; and
the metadata conversion apparatus, in response to a data search request, acquires data corresponding to the search request, acquires the inheritance information from the data management computer system, and acquires and outputs data inheriting the metadata of the directory corresponding to the search request based on the acquired inheritance information.

7. The computer system according to claim 1, wherein:
the data providing computer or the data management computer system allocates address information for identifying data to be migrated from the data providing computer to the data management computer system; and
when the data management computer system allocates address information of the data to be migrated, the data management computer system notifies the data providing computer of the address information of the data to be migrated.

8. A data management computer system for storing and managing data migrated from an external computer, the system comprising:
a storage apparatus that stores an object corresponding to the data migrated from the external computer and metadata of the object; and
a processor that executes a process of storing the data received from the external computer in the storage apparatus as an object, and a predetermined operation with respect to the object,
wherein the metadata of the object, when each object inherits metadata of an upper-level directory, includes address information for identifying the upper-level directory.

9. The data management computer system according to claim 8, wherein the processor further interprets the address information included in the metadata of each object, the address information being of an inheritance source directory the metadata of which each object inherits, and executes a metadata conversion process for acquiring the metadata of the inheritance source.

10. The data management computer system according to claim 8, further comprising a metadata conversion apparatus that interprets the address information included in the metadata of each object, the address information being of an inheritance source directory the metadata of which is inherited by each object, and that acquires the metadata of the inheritance source.

11. The data management computer system according to claim 9, wherein the processor, in response to a data search request, acquires data corresponding to the search request, and, based on the address information, acquires and outputs data that inherits, as the inheritance source, the metadata of the directory corresponding to the search request.

12. The data management computer system according to claim 9, wherein the processor, based on access permission information of the inheritance source directory inherited by data to be output, determines the presence or absence of access permission of a target of the access request.

13. The data management computer system according to claim 9, wherein:
the processor, in response to a data access request, determines whether the access request is a restore request or a normal access request; and
the processor acquires the metadata of target data of the access request in the case of a restore request, or acquires the metadata of the inheritance source directory inherited by the target data of the access request in the case of a normal access request.

14. The data management computer system according to claim 8, wherein the storage apparatus further retains, with respect to each directory object, data provided at a lower level of each directory and inheritance information indicating whether the lower-level data inherits the metadata of the upper-level directory; and
the processor, in response to a data search request, acquires data corresponding to the search request, acquires the inheritance information from the data management computer system, and acquires and outputs, based on the acquired inheritance information, data inheriting the metadata of the directory corresponding to the search request as the inheritance source.

15. A data managing method in a computer system, the computer system including at least one data providing computer that provides a user with data, and a data management computer system that is connected to the data providing computer and that stores and manages data migrated from the data providing computer,
wherein:
the data providing computer, when metadata of data to be migrated to the data management computer system inherits metadata of an upper-level directory, causes address information for identifying the upper-level directory to be included in the metadata of the data to be migrated, and transmits the data to be migrated including the metadata including the address information to the data management computer system; and
the data management computer system stores the data to be migrated that is acquired from the data providing computer in a storage apparatus together with the metadata including the address information, and manages the data.
